(19) United States
(12) Patent Application Publication
(10) Pub. No.: US 2017/0096592 A1
(43) Pub. Date: Apr. 6, 2017

(54) ACID SOLUBLE FLAKES AS LOST CIRCULATION MATERIAL

(71) Applicant: Halliburton Energy Services, Inc., Houston, TX (US)

(72) Inventors: Garima Misra, Pune (IN); Sharath Savari, Stafford, TX (US)

(21) Appl. No.: 15/311,750

(22) PCT Filed: Jun. 24, 2014
(86) PCT No.: PCT/US2014/043764

§ 371 Date: Nov. 16, 2016

(51) Int. Cl. C09K 8/035; C09K 8/516; E21B 33/138; C09K 8/514; E21B 21/00; E21B 37/00

(52) U.S. Cl. CPC C09K 8/035; E21B 21/003; E21B 37/00; E21B 33/138; C09K 8/514; C09K 8/516; C09K 2208/18

(57) ABSTRACT

Compositions and methods for formulating lost circulation materials are provided. More particularly, in certain embodiments, the present disclosure relates to drilling fluids that comprise chitosan flakes as a lost circulation material. In one embodiment, the method comprises: introducing a drilling fluid into a wellbore penetrating at least a portion of a subterranean formation, wherein the drilling fluid comprises: a base fluid; and a lost circulation material comprising chitosan flakes; and forming a filter cake or LCM plug with the chitosan flakes in at least a portion of the subterranean formation.

### BACKGROUND

The present disclosure provides compositions and methods for lost circulation materials.

Natural resources such as oil or gas residing in a subterranean formation can be recovered by drilling a wellbore that penetrates the formation. The wellbore passes through a variety of subterranean formations. This may include non-reservoir zones (i.e., formations that do not contain oil and gas) and reservoir zones (i.e., formations that do contain oil or gas). The subterranean formations may also have varying degrees of permeability. During the drilling of the wellbore, a drilling fluid may be used to, among other things, cool the drill bit, lubricate the rotating drill string to prevent it from sticking to the walls of the wellbore, prevent blowouts by serving as a hydrostatic head to the entrance into the wellbore of formation fluids, and remove drill cuttings from the wellbore. A drilling fluid may be circulated downwardly through a drill pipe and drill bit and then upwardly through the wellbore to the surface.

When the drilling fluid contacts permeable subterranean formations, fluid (e.g., water) may be lost into the formation. A drilling operation where this has occurs may also be said to have “lost circulation.” Fluid loss control additives may be included in the drilling fluid to reduce fluid loss into the formation. When the permeability of the formation is high, for example, because of unconsolidated formations or microfractures, the rate of fluid loss may increase to an extent that some conventional fluid loss control additives (e.g., polymer and copolymers) may not be effective in preventing fluid loss from the drilling fluid. In some cases, fluid loss may increase to the point where the drilling fluid can no longer be circulated back to the surface as efficiently, or at all. To help control fluid loss and/or to lost circulation, lost circulation materials (“LCM”) may be included the drilling fluid. Examples of conventional lost circulation materials include peanut shells, mica, cellophane, walnut shells, plant fibers, cottonseed hulls, ground rubber, and polymeric materials.

Fluid loss and lost circulation can be more significant during drilling operations into high-permeability zones (e.g., unconsolidated zones or depleted formations), vugular zones, and fractures (e.g., either pre-existing fractures or fractures created during the subterranean operation). In many cases when circulation losses are significant, conventional insoluble particulate materials (e.g., ground marble, nutshells, graphites, fibers) have been added to the drilling fluid. Such conventional insoluble particulate materials may form a filter cake on the walls of the wellbore or can form a LCM plug inside the formation pores or fractures. This filter cake or LCM plug may be less permeable than the wellbore walls, and, accordingly the establishment of the filter cake may reduce circulation losses.

### BRIEF DESCRIPTION OF THE DRAWINGS

These drawings illustrate certain aspects of some of the embodiments of the present disclosure, and should not be used to limit or define the claims.

FIG. 1 is a diagram illustrating an example of a system where certain embodiments of the present disclosure may be used.

FIG. 2 is a photograph of chitosan flakes that may be used according to certain embodiments of the present disclosure.

FIG. 3 is a photograph showing the initial state of an experiment to test the acid solubility of the chitosan flakes such as those in FIG. 2.

FIG. 4 is a photograph showing the final state of an experiment to test the acid solubility of the chitosan flakes such as those in FIG. 2.

FIG. 5 is a photograph showing the initial state of an experiment to demonstrate the solubility of the chitosan flakes such as those in FIG. 2 in formic acid.

FIG. 6 is a series of photographs showing intervals of an experiment to demonstrate the solubility of the chitosan flakes such as those in FIG. 2 in formic acid. FIG. 6A was taken at 2.5 hours; FIG. 6B was taken at 5 hours; and FIG. 6C was taken at 16 hours.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DESCRIPTION OF EMBODIMENTS

The present disclosure provides compositions and methods for lost circulation materials. More particularly, in certain embodiments, the present disclosure relates to drilling fluids that comprise chitosan flakes as a lost circulation material.

There may be several potential advantages to the methods and compositions of the present disclosure, only some of which are alluded to herein. The present disclosure provides acid soluble lost circulation materials that may be used to create a filter cake and/or LCM plug that can be selectively dissolved and removed from the wellbore. In certain embodiments, e.g., a non-reservoir zone, the filter cake and/or the LCM plug may be permanent and insoluble lost circulation materials can be used to reduce fluid loss and prevent lost circulation. In other embodiments, e.g., in a reservoir zone, the filter cake and/or the LCM plug may be temporary. After the well has been completed, the filter cake and/or the LCM plug often impedes the flow of hydrocarbons during production, and therefore is often removed. The need to remove the filter cake and/or LCM plug often limits the materials that are suitable as lost circulation materials. The acid soluble flakes of the present disclosure are reservoir friendly, easy to use, cost effective, and environmentally friendly.

In accordance with embodiments of the present disclosure, a drilling fluid may comprise a base fluid and a lost circulation material comprising acid soluble flakes. In preferred embodiments, the acid soluble flakes comprise flaked chitosan. The drilling fluid may comprise additional components, including but not limited to, additional lost circulation materials or bridging agents.

Base fluids suitable for use in the drilling fluids include any of a variety of fluids suitable for use in a drilling fluid. Examples of suitable base fluids include, but are not limited to, aqueous-based fluids (e.g., water, oil-in-water emulsions), oleaginous-based fluids (e.g., invert emulsions). In certain embodiments, the aqueous-based fluid comprises an aqueous liquid. In certain embodiments, the aqueous fluid may be foamed, for example, containing a foaming agent and entrained gas. Examples of suitable oleaginous fluids that may be included in the oleaginous-based fluids include, but are not limited to, a-olefins, internal olefins, alkanes, aromatic solvents, cycloalkanes, liquefied petroleum gas, kerosene, diesel oils, crude oils, gas oils, fuel oils, paraffin oils, mineral oils, low-toxicity mineral oils, olefins, esters, amides, synthetic oils (e.g., polyolefins), polydiorganosiloxanes, siloxanes, organosiloxanes, ethers, acetals, dialkylcarbonates, hydrocarbons, and combinations thereof.

Generally, the base fluid may be present in an amount sufficient to form a pumpable drilling fluid. By way of example, the base fluid may be present in the drilling fluid in an amount in the range of from about 20% to about 99.99% by volume of the drilling fluid. One of ordinary skill in the art with the benefit of this disclosure will recognize the appropriate amount of base fluid to include within the drilling fluids of the present invention in order to provide a drilling fluid for a particular application.

In addition to the base fluid, a lost circulation material may also be included in the drilling fluid, in accordance with embodiments of the present invention. The term “lost circulation material” includes materials that are capable of reducing the amount of fluid that is lost during the drilling process. The lost circulation material may be present in the drilling fluid in an amount sufficient for a particular application. For example, the lost circulation material may be included in the drilling fluid in an amount of about 1 pound per barrel to 200 pounds per barrel. A person of skill in the art, with the benefit of this disclosure, would know how much lost circulation material to include in the drilling fluid to accomplish a desired goal, depending on, for example, the permeability of the subterranean formation.

In accordance with embodiments of the present disclosure, the lost circulation material may comprise one or more acid soluble flakes. In certain embodiments, the acid soluble flakes comprise chitosan flakes. Chitosan is an amino-sugar-containing polysaccharide that may be obtained by alkaline deacetylation of chitin from crab and shrimp shells. This fibril biopolymer is composed of β-(1→4)-2-amino-2-deoxy-D-glucopyranose units (glucosamine units). It is a non-toxic, biocompatible and biodegradable polymer. The physical, chemical and biological properties of chitin and chitosan depend mainly on two parameters: degree of deacetylation and molecular weight distribution, both of which are affected by the source of chitin and the method of preparation.

In some cases, chitosan is difficult to dissolve in water, alkaline solutions or common organic solvents, due at least in part to the formation of intermolecular hydrogen bonds of its molecules. However, chitosan is soluble in most dilute aqueous acid solutions, mainly due to the presence of amino groups in its molecular structure which may be protonated in the aqueous acid solution rendering it soluble. Thus, in the preparation of a solution of chitosan, an aqueous organic acid may be used as solubilizing agent. The level of solubility of chitosan in dilute acids may depend on its molecular weight and the degree of deacetylation.

The chitosan flakes may have a variety of sizes and shapes. The chitosan flakes may appear white or off-white. The length may be greater than the width. However, chitosan flakes of any size, shape, and appearance may be useful according to embodiments of the present disclosure.

In certain embodiments, the drilling fluid may further comprise additional lost circulation materials or bridging agents. Examples of bridging agents that may be used include calcium carbonate, BARACARB® sized-ground marble which is available from Halliburton Energy Services, Inc., or N-SEAL™ which is also available from Halliburton Energy Services, Inc. BARACARB® sized-ground marble is an acid soluble engineered sized product that can be used as a bridging agent for fluid loss applications, increasing fluid density for drill-in applications, or as part of a borehole strengthening treatment in conjunction with other services.

The drilling fluid may further comprise a viscosifying agent in accordance with embodiments of the present invention. As used herein the term “viscosifying agent” refers to any agent that increases the viscosity of a fluid. By way of example, a viscosifying agent may be used in a drilling fluid to impart a sufficient carrying capacity and/or thixotropy to the drilling fluid, enabling the drilling fluid to transport drill cuttings and/or weighting materials, prevent the undesired settling of the drilling cuttings and/or weighting materials.

Where present, a variety of different viscosifying agents may be used that are suitable for use in a drilling fluid. Examples of suitable viscosifiers include, inter alia, biopolymers (e.g., xanthan and succinoglycan), cellulose, cellulose derivatives (e.g., hydroxyethylcellulose), guar, and guar derivatives (e.g., hydroxypropyl guar). In certain embodiments of the present invention, the viscosifier is guar. Commercially available examples of suitable viscosifiers include, but are not limited to, those that are available from Halliburton Energy Services, Inc., under the trade name N-VIS®. Combinations of viscosifying agents may also be suitable. The particular viscosifying agent used depends on a number of factors, including the viscosity desired, chemical compatibility with other fluids used in formation of the wellbore, and other wellbore design concerns.

The drilling fluid according to the present disclosure may further comprise additional additives as deemed appropriate by one of ordinary skill in the art, with the benefit of this disclosure. Examples of such additives include, but are not limited to, emulsifiers, wetting agents, dispersing agents, shale inhibitors, pH-control agents, filtration-control agents, alkalinity sources such as lime and calcium hydroxide, salts, or combinations thereof

In accordance with embodiments of the present invention, a drilling fluid that comprises a base fluid and chitosan flakes may be used in drilling a wellbore. In certain embodiments, a drill bit may be mounted on the end of a drill string that may comprise several sections of drill pipe. The drill bit may be used to extend the wellbore, for example, by the application of force and torque to the drill bit. A drilling fluid may be circulated downwardly through the drill pipe, through the drill bit, and upwardly through the annulus between the drill pipe and wellbore to the surface. In an embodiment, the drilling fluid may be employed for general drilling of wellbore in subterranean formations, for example, through non-producing zones. In another embodiment, the drilling fluid may be designed for drilling through hydrocarbon-bearing zones.

As the drilling fluid is circulated through the wellbore, the chitosan flakes may form a filter cake along the walls of the wellbore and/or an LCM plug within the formation pores or fractures. Because chitosan flakes are relatively insoluble in water, alkaline solutions, and common organic solvents, in certain embodiments, these solid chitosan flakes may be capable of forming a barrier between the wellbore and the subterranean formation, which may otherwise be permeable. This can, among other benefits, reduce the fluid loss and prevent lost circulation while the wellbore is being drilled and/or during subsequent treatments in the wellbore.

After the wellbore has been drilled, the chitosan flakes may be removed from the walls of the wellbore in the reservoir zone, among other reasons, to restore the permeability so that gas and/or oil can be produced from the zone and flow out of the formation through the wellbore. The chitosan flakes may be removed by using an acid solution. In those embodiments, the acid solution may be introduced through the wellbore after at least a portion of the drilling has been completed. The acid solution contacts the chitosan flakes and at least partially dissolves them. In certain cases, the chitosan flakes may be completely dissolved. The dissolved chitosan flakes may then be safely removed from the wellbore. For example, the acid solution may be pumped to the surface of the wellbore directly. Alternatively, a well servicing fluid and/or other fluid carrying the dissolved chitosan flakes (or dissolved portions thereof) may be circulated in the wellbore to remove the acid solution and the dissolved chitosan flakes.

The acid solution is placed into contact with the chitosan flakes for a duration of time sufficient to at least partially dissolve the chitosan flakes. In one embodiment, the acid solution is placed into contact with the chitosan flakes for up to 4 hours. In another embodiment, the acid solution is placed into contact with the chitosan flakes for as long as 72 hours. With the benefit of this disclosure, a person of skill in the art can determine the optimal amount of time for the acid solution to be in contact with the chitosan flakes based on, for example, the temperature and/or pressure conditions in the wellbore, and/or other facts. With the benefit of this disclosure, a person of skill in the art may adjust the amount of time during the course of a treatment depending upon, for example, the observed progress of the treatment and/or other facts.

A variety of acid solutions may be used to at least partially dissolve the chitosan flakes. Examples of acid solutions that may be suitable for use in the methods of the present disclosure include, but are not limited to, aqueous organic acids. In one embodiment, the acid solution comprises formic acid. In certain embodiments, the acid solution has a concentration of about 1% to about 15%. In other embodiments, the acid solution has a concentration of about 1% to about 50%.

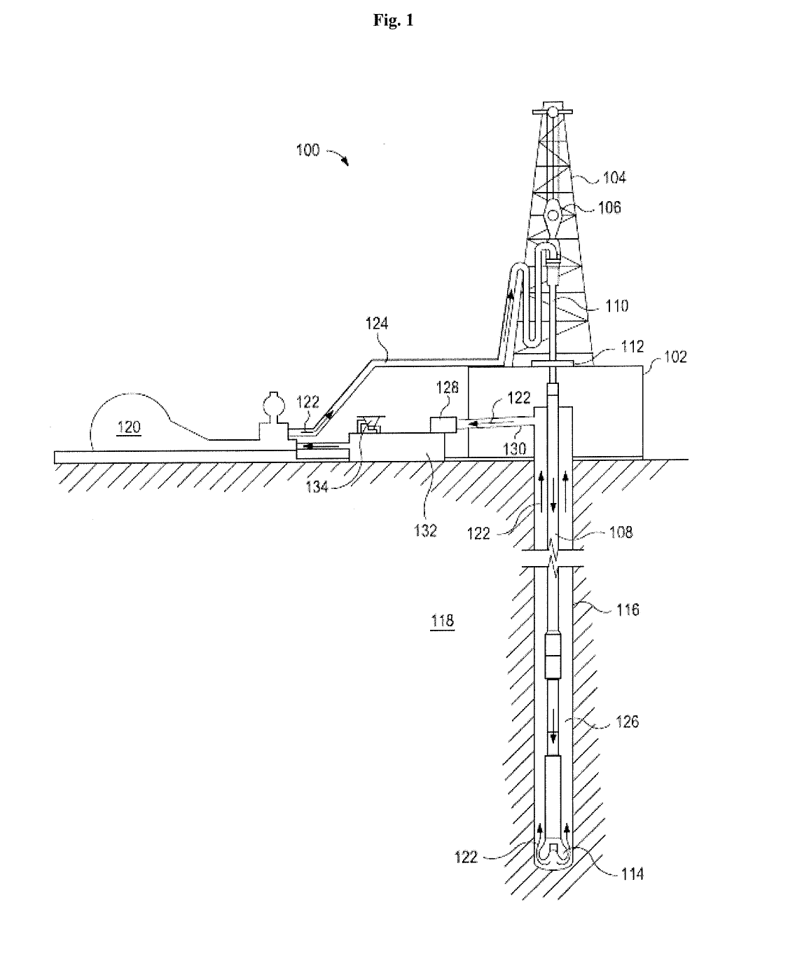

The lost circulation materials and/or other compositions disclosed herein may directly or indirectly affect one or more components or pieces of equipment associated with the preparation, delivery, recapture, recycling, reuse, and/or disposal of the disclosed lost circulation material. For example, and with reference to FIG. 1, the disclosed lost circulation material may directly or indirectly affect one or more components or pieces of equipment associated with an exemplary wellbore drilling assembly 100, according to one or more embodiments. It should be noted that while FIG. 1 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a borehole 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the borehole 116. At the surface, the recirculated or spent drilling fluid 122 exits the annulus 126 and may be conveyed to one or more fluid processing unit(s) 128 via an interconnecting flow line 130. After passing through the fluid processing unit(s) 128, a “cleaned” drilling fluid 122 is deposited into a nearby retention pit 132 (i.e., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the scope of the disclosure.

One or more of the disclosed lost circulation materials may be added to the drilling fluid 122 via a mixing hopper 134 communicably coupled to or otherwise in fluid communication with the retention pit 132. The mixing hopper 134 may include, but is not limited to, mixers and related mixing equipment known to those skilled in the art. In other embodiments, however, the disclosed lost circulation material may be added to the drilling fluid 122 at any other location in the drilling assembly 100. In at least one embodiment, for example, there could be more than one retention pit 132, such as multiple retention pits 132 in series. Moreover, the retention put 132 may be representative of one or more fluid storage facilities and/or units where the disclosed lost circulation material may be stored, reconditioned, and/or regulated until added to the drilling fluid 122.

As mentioned above, the disclosed lost circulation materials and/or other compositions may directly or indirectly affect the components and equipment of the drilling assembly 100. For example, the disclosed lost circulation materials and/or other compositions may directly or indirectly affect the fluid processing unit(s) 128 which may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, or any fluid reclamation equipment. The fluid processing unit(s) 128 may further include one or more sensors, gauges, pumps, compressors, and the like used store, monitor, regulate, and/or recondition the exemplary lost circulation material.

The disclosed lost circulation materials and/or other compositions may directly or indirectly affect the pump 120, which representatively includes any conduits, pipelines, trucks, tubulars, and/or pipes used to fluidically convey the lost circulation material downhole, any pumps, compressors, or motors (e.g., topside or downhole) used to drive the lost circulation material into motion, any valves or related joints used to regulate the pressure or flow rate of the lost circulation material, and any sensors (i.e., pressure, temperature, flow rate, etc.), gauges, and/or combinations thereof, and the like. The disclosed lost circulation material may also directly or indirectly affect the mixing hopper 134 and the retention pit 132 and their assorted variations.

The disclosed lost circulation materials and/or other compositions may also directly or indirectly affect the various downhole equipment and tools that may come into contact with the lost circulation material such as, but not limited to, the drill string 108, any floats, drill collars, mud motors, downhole motors and/or pumps associated with the drill string 108, and any MWD/LWD tools and related telemetry equipment, sensors or distributed sensors associated with the drill string 108. The disclosed lost circulation material may also directly or indirectly affect any downhole heat exchangers, valves and corresponding actuation devices, tool seals, packers and other wellbore isolation devices or components, and the like associated with the wellbore 116. The disclosed lost circulation material may also directly or indirectly affect the drill bit 114, which may include, but is not limited to, roller cone bits, PDC bits, natural diamond bits, any hole openers, reamers, coring bits, etc.

While not specifically illustrated herein, the disclosed lost circulation materials and/or other compositions may also directly or indirectly affect any transport or delivery equipment used to convey the lost circulation material to the drilling assembly 100 such as, for example, any transport vessels, conduits, pipelines, trucks, tubulars, and/or pipes used to move the lost circulation material from one location to another, any pumps, compressors, or motors used to drive the lost circulation material into motion, any valves or related joints used to regulate the pressure or flow rate of the lost circulation material, and any sensors (i.e., pressure and temperature), gauges, and/or combinations thereof, and the like.

### EXAMPLES

To facilitate a better understanding of the present disclosure, the following examples of certain aspects of some embodiments are given. In no way should the following examples be read to limit or define the scope of the claims.

### Example 1

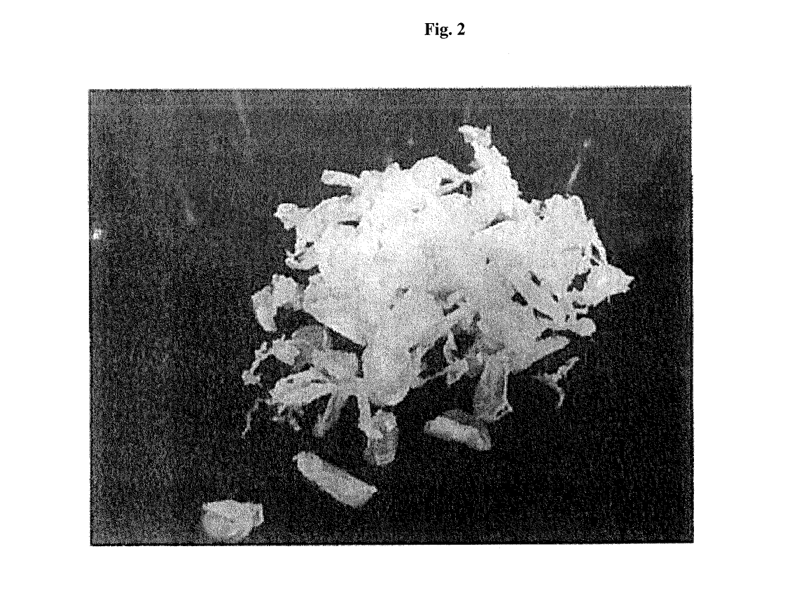

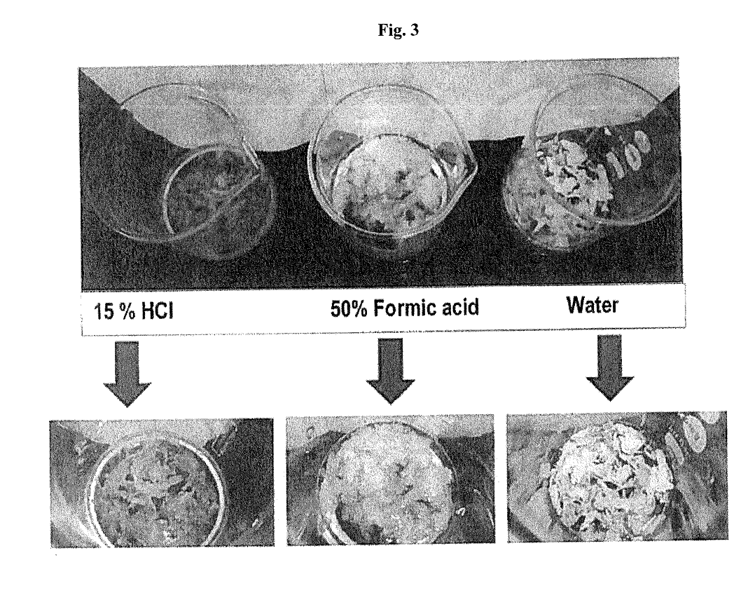

The following experiment was conducted to test the acid solubility of the chitosan flakes. The chitosan flakes used in this experiment are shown in FIG. 2. Three beakers were prepared. The first contained 100 mL of 15% HCl. The second contained 100 mL of 50% formic acid. The third contained 100 mL of water. About 0.75 grams of chitosan flakes were added to each of the beakers. FIG. 3 shows the three beakers after the chitosan flakes have been added: the 15% HCl is on the left, the 50% formic acid is in the middle, and the water is on the right.

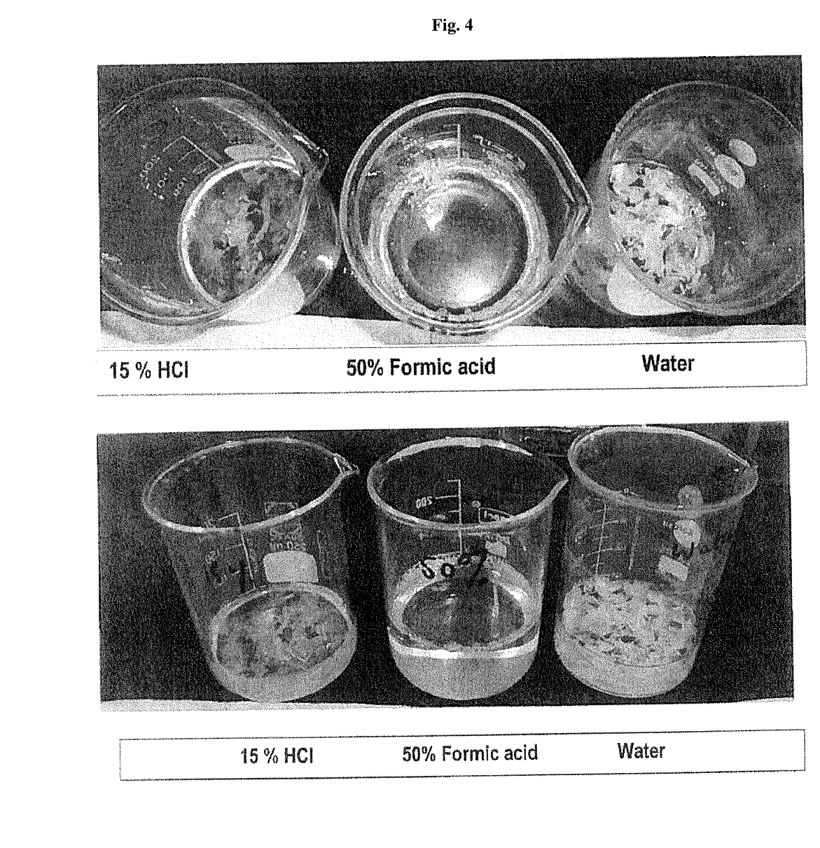

The chitosan flakes were left in their respective beakers for approximately 16 hours. FIG. 4 shows the three beakers after that time had passed. Again, the 15% HCl is on the left, the 50% formic acid is in the middle, and the water is on the right. As shown in FIG. 4, the chitosan flakes were completely dissolved in the 50% formic acid while they remained undissolved in the 15% HCl and water.

### Example 2

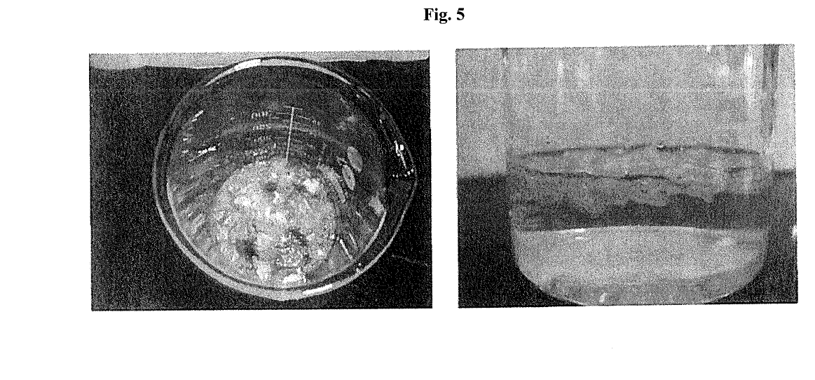

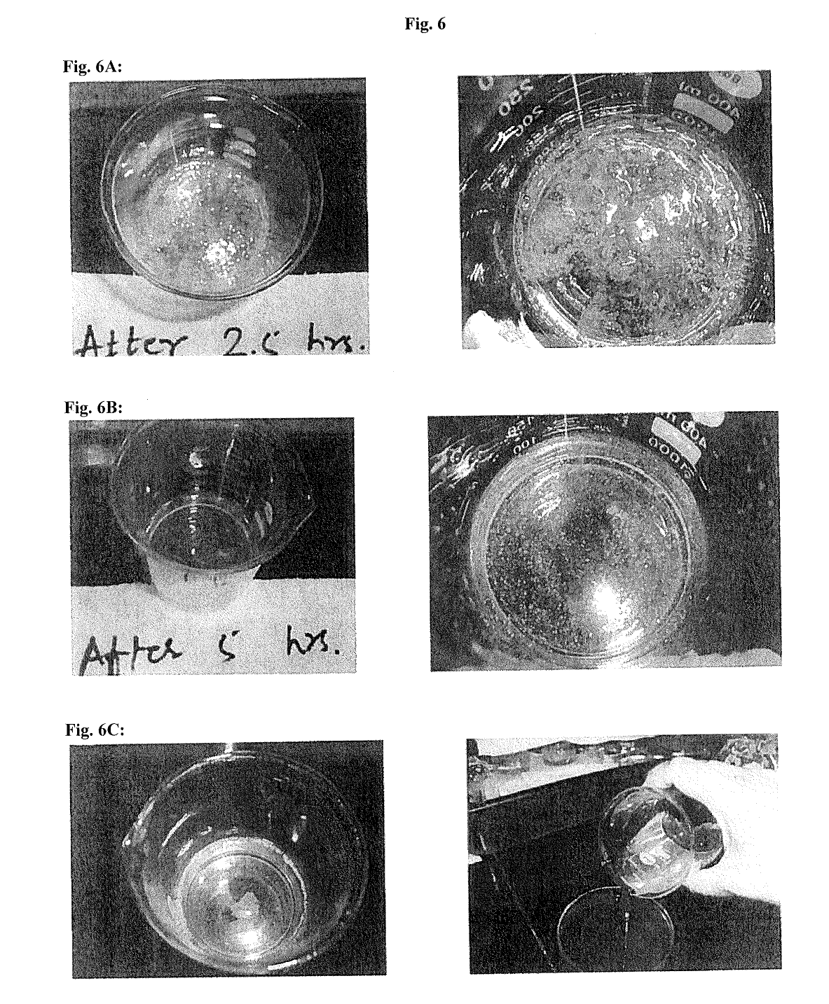

The following example illustrates the solubility of the chitosan flakes in formic acid. A beaker was prepared with 100 mL of 15% formic acid. About 0.75 grams of chitosan flakes were added to the beaker. FIG. 5 shows the beaker immediately after the chitosan flakes were added. The photographs in FIG. 6 show the beaker at various intervals. FIG. 6A was taken at 2.5 hours; FIG. 6B was taken at 5 hours; and FIG. 6C was taken at 16 hours. As shown in FIG. 6, by 16 hours, the chitosan flakes had dissolved.

An embodiment of the present disclosure is a method comprising: introducing a drilling fluid into a wellbore penetrating at least a portion of a subterranean formation, wherein the drilling fluid comprises: a base fluid; and a lost circulation material comprising chitosan flakes; and forming a filter cake or LCM plug with the chitosan flakes in at least a portion of the subterranean formation. Optionally, the drilling fluid further comprises a bridging agent. Optionally, the chitosan flakes are present in the drilling fluid in an amount of from about 1 pound per barrel to about 200 pounds per barrel. Optionally, the method further comprises using the drilling fluid to drill at least a portion of the wellbore. Optionally, the method further comprises introducing an acid solution into the well; and contacting at least a portion of the filter cake or LCM plug with the acid solution to at least partially dissolve at least a portion of the filter cake or LCM plug. Optionally, the drilling fluid further comprises a bridging agent. Optionally, the acid solution comprises an organic acid. Optionally, the organic acid comprises formic acid. Optionally, the drilling fluid is introduced into the wellbore using at least one mud pump.

Another embodiment of the present disclosure is a method comprising: introducing a drilling fluid into a wellbore penetrating at least a portion of a subterranean formation, wherein the drilling fluid comprises: a base fluid; and a lost circulation material comprising chitosan flakes; forming a filter cake or LCM plug with the chitosan flakes in at least a portion of the subterranean formation; introducing an acid solution into the well; contacting at least a portion of the filter cake or LCM plug with the acid solution to at least partially dissolve at least a portion of the filter cake or LCM plug; and using a circulated fluid to remove the dissolved filter cake or LCM plug from the wellbore. Optionally, the drilling fluid further comprises a bridging agent. Optionally, the chitosan flakes are present in the drilling fluid in an amount of from about 1 pound per barrel to about 200 pounds per barrel. Optionally, the filter cake or LCM plug is contacted with the acid solution for at least 1 hour. Optionally, the acid solution comprises an organic acid. Optionally, the organic acid comprises formic acid.

Another embodiment of the present disclosure is a composition comprising: a base fluid; a lost circulation material comprising chitosan flakes; and a bridging agent. Optionally, the bridging agent comprises ground marble. Optionally, the bridging agent comprises calcium carbonate. Optionally, the chitosan flakes are present in the drilling fluid in an amount of from about 1 pound per barrel to about 200 pounds per barrel. Optionally, the composition further comprises an additional additive selected from the group consisting of emulsifiers, wetting agents, dispersing agents, shale inhibitors, pH-control agents, filtration-control agents, alkalinity sources, salts, and combinations thereof

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A method comprising:
introducing a drilling fluid into a wellbore penetrating at least a portion of a subterranean formation, wherein the drilling fluid comprises:
a base fluid; and
a lost circulation material comprising chitosan flakes; and
forming a filter cake or LCM plug with the chitosan flakes in at least a portion of the subterranean formation.

2. The method of claim 1 wherein the drilling fluid further comprises a bridging agent.

3. The method of claim 1 wherein the chitosan flakes are present in the drilling fluid in an amount of from about 1 pound per barrel to about 200 pounds per barrel.

4. The method of claim 1 further comprising using the drilling fluid to drill at least a portion of the wellbore.

5. The method of claim 1 further comprising:
introducing an acid solution into the well; and
contacting at least a portion of the filter cake or LCM plug with the acid solution to at least partially dissolve at least a portion of the filter cake or LCM plug.

6. The method of claim 5 wherein the drilling fluid further comprises a bridging agent.

7. The method of claim 5 wherein the acid solution comprises an organic acid.

8. The method of claim 7 wherein the organic acid comprises formic acid.

9. The method of claim 5 wherein the drilling fluid is introduced into the wellbore using at least one mud pump.

10. A method comprising:
introducing a drilling fluid into a wellbore penetrating at least a portion of a subterranean formation, wherein the drilling fluid comprises:
a base fluid; and
a lost circulation material comprising chitosan flakes;
forming a filter cake or LCM plug with the chitosan flakes in at least a portion of the subterranean formation;
introducing an acid solution into the well;
contacting at least a portion of the filter cake or LCM plug with the acid solution to at least partially dissolve at least a portion of the filter cake or LCM plug; and
using a circulated fluid to remove the dissolved filter cake or LCM plug from the wellbore.

11. The method of claim 10 wherein the drilling fluid further comprises a bridging agent.

12. The method of claim 10 wherein the chitosan flakes are present in the drilling fluid in an amount of from about 1 pound per barrel to about 200 pounds per barrel.

13. The method of claim 10 wherein the filter cake or LCM plug is contacted with the acid solution for at least 1 hour.

14. The method of claim 10 wherein the acid solution comprises an organic acid.

15. The method of claim 14 wherein the organic acid comprises formic acid.

16. A composition comprising:
a base fluid;
a lost circulation material comprising chitosan flakes; and
a bridging agent.

17. The composition of claim 16 wherein the bridging agent comprises ground marble.

18. The composition of claim 16 wherein the bridging agent comprises calcium carbonate.

19. The composition of claim 16 wherein the chitosan flakes are present in the drilling fluid in an amount of from about 1 pound per barrel to about 200 pounds per barrel.

20. The composition of claim 16 further comprising an additional additive selected from the group consisting of emulsifiers, wetting agents, dispersing agents, shale inhibitors, pH-control agents, filtration-control agents, alkalinity sources, salts, and combinations thereof.
